(19) United States
(12) Patent Application Publication
(10) Pub. No.: US 2018/0162752 A1
(43) Pub. Date: Jun. 14, 2018

(54) AN APPARATUS FOR REMOVAL OF IONS FROM WATER AND METHOD OF PRODUCING THE SAME

(71) Applicant: VOLTEA B.V., Sassenheim (NL)

(72) Inventors: Albert VAN DER WAL, Oegstgeest (NL); Leonard Bryan BRISTER, Gulfport, MS (US); Piotr Edward DLUGOLECKI, Leiden (NL)

(21) Appl. No.: 15/577,573

(22) PCT Filed: May 27, 2016
(86) PCT No.: PCT/EP2016/062055

§ 371 Date: Nov. 28, 2017

(30) Foreign Application Priority Data
May 29, 2015 (EP) 15169949.3

(51) Int. Cl. C02F 1/469; C02F 1/42; B01D 61/48

(52) U.S. Cl. CPC C02F 1/4691; C02F 1/42; C02F 1/4695; C02F 2307/12; C02F 2001/425; C02F 2001/422; B01D 61/48

(57) ABSTRACT

An apparatus for removal of ions from water, the apparatus includes: a first functional layer system including a carbon coated first current collector and optionally a first charge barrier layer; a second functional layer system including a carbon coated second current collector and optionally a second charge barrier; and a spacer between the first and second functional layer systems to allow water to flow in between the first and second functional layer systems. An ionomer is provided to the first functional layer system and/or second functional layer system.

### FIELD

The invention relates to an apparatus for removal of ions from water (e.g. Flow Through Capacitor; FTC), the apparatus comprising:

a first functional layer system comprising a carbon coated first current collector and optionally a first charge barrier layer;

a second functional layer system comprising a carbon coated second current collector and optionally a second charge barrier; and

a spacer in between the first and second functional layer system to allow water to flow in between the first and second functional layer system.

### BACKGROUND

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionisation, using an apparatus provided with a flow through capacitor (FTC) for removal of ions in water. The FTC functions as an electrically re-generable cell for capacitive deionisation. By charging electrodes, ions are removed from an electrolyte and are held in electric double layers at the electrodes. The electrodes can be (partially) electrically regenerated to desorb such previously removed ions without adding chemicals.

The apparatus for removal of ions comprises one or more pairs of spaced apart electrodes (a cathode and an anode) and a spacer, separating the electrodes and allowing water to flow between the electrodes. The electrodes are provided with current collectors or backing layers and a high surface area material, such as e.g. carbon, which may be used to store removed ions. The current collectors may be in direct contact with the high surface area material. Current collectors are electrically conductive and transport charge in and out of the electrodes and into the high surface area material.

A charge barrier may be placed adjacent to an electrode of the flow-through capacitor. The term charge barrier refers to a layer of material which is permeable or semi-permeable for ions and is capable of holding an electric charge. Ions with opposite charge as the charge barrier charge can pass the charge barrier material, whereas ions of similar charge as the charge of the charge barrier cannot pass the charge barrier material. Ions of similar charge as the charge barrier material are therefore contained or trapped either in e.g. the electrode compartment and/or in the spacer compartment. The charge barrier may comprise an ion exchange material provided in a membrane. A membrane provided with ion exchange material may allow an increase in ionic efficiency, which in turn allows energy efficient ion removal.

U.S. Pat. No. 8,730,650 discloses a flow through capacitor wherein the anode comprises a coated anode current collector comprising carbon having a specific surface area of at least 500 m²/g and polyelectrolyte. The cationic polyelectrolyte is adsorbed onto the carbon. The drawback of such a flow through capacitor is that part of the available surface area of the carbon is used for adsorption of the polyelectrolyte, which lowers the ion adsorption capacity and in addition, only limited amounts of polyelectrolyte can be absorbed onto the carbon.

WO01/20060 discloses an electrodeionization apparatus containing electrodes provided with ion exchanging solids which may be in particle or fiber form. A particle size of 500-600 micrometer is considered typical. Further disclosures pertaining to electrodeionization methods with electrodes provided with ion exchanging solids are WO 2015/005250; KIM Y J ET AL: “Improvement of desalination efficiency in capacitive deionization using a carbon electrode coated with an ion-exchange polymer”, WATER RESEARCH, ELSEVIER, AMSTERDAM, NL, vol. 44, no. 3, 1 Feb. 2010 (2010-02-01), pages 990-996; Ayu Tyas Utami Nugrahenny ET AL: “Development of High Performance Cell Structure for Capacitive Deionization using Membrane PolymerCoated Electrode”, CISAK 2013—Conference of the Indonesian Students Association at Korea (PERPIKA), Daejeon, South Korea Jul. 6-7, 2013, 6 Jul. 2013. However, improvements are still needed.

FIG. 1a gives a schematic representation of the charging of the carbon coated current collector during the ion removal step. During ion removal, anion 1 passes the anion exchange membrane 3 (charge barrier) and enters into the carbon electrode (the first carbon coated current collector) 5. These ions are mainly stored in the electrical double layers that are formed at the carbon-water interface upon electrically charging of the electrode 5. In this example the anions 1 can pass the membrane 3, whereas the cations 7 cannot. The cations 7 are expelled from the carbon-water interface, but cannot pass the membrane 3 and are therefore accumulated inside the electrode pores.

FIG. 1b gives a schematic representation of the discharging of the carbon coated current collector during the electrode regeneration step at reversed potential. During electrode regeneration at reversed potential, the electrode 5 is now negatively charged and the countercharge therefore consists mainly of cations 7. These cations are accumulated at the carbon-water interface. Hydroxide ions and protons may also pass the charge barrier 3 and may be adsorbed into the carbon coated current collector 5. The adsorption capacity of the hydroxide ions and protons onto the carbon coated current collector 5 may be different and or the transport of these ions through the charge barrier 3 may be different. This may lead to a change in the ratio of the hydroxide ions and protons in the spacer compartment, which may lead to a variation in the pH in the spacer compartment during charging and discharging of the electrodes.

The functioning of the flow through capacitor may not be optimal because the carbon coated first current collector may have insufficient buffer capacity to adsorb hydroxide and/or protons that are transported and/or formed during the charging and discharging of the carbon coated current collector. This can lead to non-desirable fluctuation of the pH during charging and discharging of the flow through capacitor. An increase of the pH during charging and/or discharging of the electrode is undesirable, because of the potential risk of scale formation in the flow through capacitor.

### SUMMARY

It is an objective of the invention to provide an improved apparatus for removal of ions from water.

Accordingly, there is provided an apparatus for removal of ions from water, the apparatus comprising:

a first functional layer system comprising a carbon coated first current collector and optionally a first charge barrier layer;

a second functional layer system comprising a carbon coated second current collector and optionally a second charge barrier; and

a spacer in between the first and second functional layer system to allow water to flow in between the first and second functional layer system, wherein an ionomer is provided to at least one of the first and second functional layer systems.

The charge barrier may be positioned in between the carbon coated first or second current collector and the spacer to selectively allow anions or cations to flow through the charge barrier from the spacer to the carbon coated first or second current collector. The charge barrier may be provided with an ionomer.

By providing ionomer to the first or second functional layer system the adsorption capacity of the electrode for hydroxide ions and/or protons is increased and therefore variations in the pH during operation of the flow through capacitor may be reduced improving the functioning of the flow through capacitor.

According to a further embodiment the charge density of the ionomer is at least between 0.2 meq and 8 meq per gram dry weight of ionomer, more preferably between 1.0 meq and 6 meq per gram dry weight of ionomer and most preferably between 2.0 meq and 5 meq per gram dry weight of ionomer.

In this way the capacity of adsorbing of the ionomer is sufficient to absorb sufficient hydroxide ions and/or protons.

According to a further embodiment the ionomer is a particle with a size between 0.1 μm and 2 mm, more preferably between 1 μm and 500 μm still more preferably between 5 μm and 100 μm. A preferred embodiment of the invention employs ionomers having a particle size below 300 μm, preferably between 5 and 300 μm. In a more preferred embodiment more than 95% of the particles have a particle size of below 300 μm, preferably between 5 and 300 μm. When using ionomer particles having a particle size of below 300 μm, preferably between 5 and 300 μm and even more preferably wherein more than 95% of the particles have a particle size of below 300 μm, preferably between 5 and 300 μm, it was found that it was easier to coat the current collectors than with ionomers having larger particle diameters. It was further found that larger ionomer particles (i.e. >300 μm) or ionomer mixtures that contain a relative high percentage of larger ionomer particles have a higher tendency to aggregate into larger clusters which not only are less easy to coat but also result in less good properties when used in an electrodeionization apparatus.

According to an embodiment the ionomer comprises an ion exchange resin.

Ion exchange resins are very effective in adsorbing protons or hydroxide ions.

According to an embodiment the ionomer comprises an ionic group to bind hydroxide ions or protons.

The ionic group is very effective in adsorbing protons or hydroxide ions.

According to an embodiment the first functional layer system comprises a positively charged ionomer capable of adsorbing hydroxide ions.

The positively charged ionomer is capable of adsorbing hydroxide thereby variations in the pH during operation of the flow through capacitor may be reduced improving the functioning of the flow through capacitor. The first functional layer system that comprises the positively charged ionomer and that is capable of adsorbing hydroxide during the operation of the flow through capacitor can also be indicated as the “anode”. In a preferred embodiment of the invention, only the first functional layer system comprises an ionomer.

According to a further embodiment the positively charged ionomer comprises a tertiary or quaternary ammonium group. In the present invention, there is a preference for quaternary ammonium anion exchange groups. Quaternary ammonium anion exchange groups can be divided to two main groups depending on the type of amine used during the chemical activation:

1. Type 1—to the amine group there are 3 alkyl (usually methyl) groups attached. This type has a higher affinity to bicarbonate, bisulfite, chloride, nitrates etc.

2. Type 2—to the amine group there are 2 alkyl (usually methyl) groups attached and 1 ethanol group. This type has a lower affinity to bicarbonate, bisulfite, chloride and nitrates, which can be beneficial to control pH.

A preference for quaternary ammonium anion exchange groups is dependent on the application of the apparatus for removal of ions from water.

According to an embodiment the second functional layer system comprises a negatively charged ionomer capable of adsorbing protons.

The negatively charged ionomer is capable of adsorbing protons thereby variations in the pH during operation of the flow through capacitor may be reduced improving the functioning of the flow through capacitor.

According to an embodiment the negatively charged ionomer comprises a sulphonic or carboxylic acid groups.

According to a further embodiment the ionomer of the first and second carbon coated current collectors have an opposite charge.

Thereby one of the ionomer is capable of adsorbing protons while the other is capable of adsorbing hydroxide ions.

According to an embodiment the first charge barrier is capable of allowing the selective transport of anions through the first charge barrier.

The first charge barrier is improving the efficiency of the carbon coated first current collector.

According to an embodiment the second charge barrier is capable of allowing the selective transport of cations through the second charge barrier.

The second charge barrier is improving the efficiency of the carbon coated second current collector.

According to an embodiment the first charge barrier comprises a positively charged ionomer.

The ionomer is capable of adsorbing hydroxide ions in the first charge barrier thereby variations in the pH during operation of the flow through capacitor may be reduced improving the functioning of the flow through capacitor.

According to an embodiment the second charge barrier comprises a negatively charged ionomer.

The ionomer is capable of adsorbing protons in the second charge barrier layer thereby variations in the pH during operation of the flow through capacitor may be reduced improving the functioning of the flow through capacitor.

According to an embodiment the first current collector comprises a positively charged ionomer.

The ionomer is capable of adsorbing hydroxide ions in the first current collector thereby variations in the pH during operation of the flow through capacitor may be reduced improving the functioning of the flow through capacitor.

According to an embodiment the second current collector comprises a negatively charged ionomer.

The ionomer is capable of adsorbing protons in the second current collector thereby variations in the pH during operation of the flow through capacitor may be reduced improving the functioning of the flow through capacitor.

The second current collector may be the cathode and the first current collector may be the anode.

According to a further embodiment the first charge barrier layer is the ionomer charge barrier layer and comprises a positively charged ionomer.

According to an embodiment of the invention there is provided a method of producing a carbon coated current collector comprising an ionomer by:

preparing a carbon paste comprising the ionomer;

providing a graphite foil; and,

coating the carbon paste onto the graphite foil.

According to a further embodiment the carbon paste comprises preferably between 5 and 40 wt % ionomer, more preferably between 10 and 25 wt % and most preferably between 13 and 18 wt % ionomer.

According to a further embodiment of the invention there is provided a method of producing a charge barrier comprising an ionomer by:

preparing a charge barrier solution (e.g. membrane coating solution) comprising the ionomer; and

coating the charge barrier solution into a layer.

According to an embodiment the charge barrier solution is coated on a coated current collector.

According to an embodiment the charge barrier solution comprises preferably between 5 and 50 wt % ionomer, more preferably between 15 and 40 wt % and most preferably between 25 and 35 wt % ionomer.

The first and/or second charge barrier may be between 1 to 400, preferably 3 to 200, more preferably 10 to 150 micron thick. With this thickness the first and/or second charge barrier may be selective enough to remove anions or cations from the water. The thickness of the charge barrier layer may depend on the roughness of the surface of the carbon of the carbon coated first or second current collector. If the surface of the carbon coated first current collector is very rough then the first charge barrier may be thicker to make the surface of the first functional layer flat.

The first and second carbon coated current collector may comprise different ionomer material. Both layers may have different requirements or specifications.

The apparatus may comprise an anode and a cathode and the carbon coated first current collector may function as the anode and may be provided with ionomer. The ionomer of the anode may be positively charged and the ionomer of the cathode may be negatively charged. The function of the anode may therefore be optimized by choosing the right specifications of the ionomer that are used in the first and second carbon coated current collectors.

The apparatus may comprise an anode and a cathode and the first current collector may function as the cathode and may be provided with a first charge barrier layer and the cathode and/or the first charge barrier layer may contain negatively charged ionomer

The first and second charge barrier layers may be separate barrier layers assembled together in a stack. During manufacturing the first charge barrier may be pressed against the first carbon coated current collector.

According to an embodiment of the invention there is provided a method of producing a functional layer system comprising ionomer, the method comprises:

providing a graphite foil;

preparing a carbon paste comprising an ionomer;

coating the carbon paste onto the graphite foil to produce a carbon coated current collector;

providing a charge barrier in contact with the carbon coated current collector to selectively allow anions or cations to pass through the charge barrier.

According to an embodiment of the invention there is provided a functional layer system comprising a carbon coated current collector and optionally a charge barrier, wherein an ionomer is provided to the functional layer system.

By providing ionomer to the first or second functional layer system the adsorption capacity of the electrode for hydroxide ions and/or protons is increased and therefore variations in the pH during operation of the flow through capacitor may be reduced improving the functioning of the flow through capacitor.

According to an embodiment of the invention there is provided a method of producing a coated current collector comprising:

preparing the carbon paste comprising:
50-94.0 dry mass weight % of carbon having a specific surface area of at least 500 m²/g,
1-40 dry mass weight % of binder,
5-45 dry mass weight % of ionomer, and
20-80% based on the total paste of solvent; and

applying the coating paste on a graphite foil; and

drying the coated current collector.

One advantage of adding the ionomer to the carbon paste for the carbon coated current collector is that the ionomer may adsorb hydroxide ions and protons from the spacer compartment thereby increasing the adsorption capacity. This may lead to less variation in the pH during charging and discharging of the apparatus.

A further improvement of the apparatus may be obtained by coating a charge barrier on top of the carbon coated current collector, whereby the charge barrier is in intimate contact with the carbon coated current collector. The coated charge barrier layer may also contain ionomer to further increase the hydroxide ion and proton adsorption capacity of the apparatus.

### Carbon

The carbon in the coating comprises activated carbon, and optionally any other carbon material, such as carbon black. The activated carbon may be steam activated or chemically activated carbon, preferably steam activated carbon, such as DLC A Supra Eur (ex Norit). The carbon preferably has a specific surface area of at least 500 m2/g, preferably at least 1000 m2/g, more preferable at least 1500 m2/g. The anode and cathode may even be made out of different carbon materials. The higher the specific surface area of the carbon is, the higher the ion storage capacity of the current collector is. The specific surface area of carbon may for instance be measured by the B.E.T. method, as commonly used in the art.

The carbon may be present in the coating in a concentration of at least 50%, preferably at least 60%, more preferable at least 70%, or even more preferably at least 75% by weight of the dry coating. The composition generally does not contain more than 98.5% by weight of the dry coating of carbon.

### Binder

The binder may be mixable with carbon material. Preferably the binder is a water based adhesive. Binder systems may be selected for their ability to wet the carbon particle or current collector materials, or surfactants or other agents may be added to the binder mixture to better wet the carbon particles, ionomer particles or graphite foil. A dispersant or a dispersing agent is a surface active substance which may be added to the carbon coating paste to improve the dispersion of the carbon particles, ionomer particles and by preventing them from settling and clumping throughout manufacture, storage, application and film formation.

A dispersant may also be added to the carbon coating paste to stabilize the binder or improve the dispersion of the binder, especially for binders that are water based adhesives. A dispersant may be any type of surfactant or any type of emulsifier and may be selected on the basis of the hydrophilic-lipophilic balance number. The dispersants may be synthetic detergents, soaps, polymeric surfactants or any type of uncharged polymers, especially water soluble polymers or any mixtures thereof. Detergent surfactants can be anionic, cationic or nonionic or mixtures thereof. Surfactants may be sodium dodecylsulphate, alkyl benzene sulphonate or alkyl ethoxylate and amine oxide surfactants. Dispersants that are used in the inkjet or paint and coating industry, such as Solsperse® and and Disperbyk® and many others may also be used.

The dispersant may also be a polyelectrolyte. However, a polyelectrolyte may also be added in addition to a dispersant, because that makes it possible to optimize both the electrolyte and the dispersant independent of each other. For example, the optimal amount of polyelectrolyte may be different than the optimal amount of dispersant and by optimizing them independently the dispersant and the polyelectrolyte may be present in the optimal amounts.

Examples of uncharged polymers are polyethylene oxide, polyethylene glycol and polyvinyl pyrrolidone (PVP, e.g. the Luvitec® range or the PVP range from International Speciality Products (ISP).

Suitable commercial binder materials may be polyacrylic based binders such as the Fastbond™ range from 3M™.

The binder may be present in the coating in a concentration of at least 1%, preferably at least 2%, more preferable at least 5% by weight of the dry coating. The binder is preferably present in the coating in a concentration of less than 50%, preferably less than 40%, more preferably less than 30%, even more preferably less than 20%, still more preferably less than 15% by weight of the dry coating.

### Ionomers

An ionomer may be added to the carbon coating paste or to a membrane solution to produce the charge barrier. Ionomers have ionizable units positioned sparsely along uncharged hydrophobic sequences. The ionizable units facilitate swelling by a polar solvent but the poor quality of such solvents for the hydrophobic sequences prevents polymer dissolution, maintaining solid-like mechanical integrity. In other words, ionomers are polymers containing chemically bound ions within their structure and are insoluble in water. Ionomers differ from polyelectrolytes, which contain higher ion content and which are soluble in water. Ionomers may be copolymers containing a non-ionic polymer backbone as the major component and an ionic part together with its counter ion as a minor component. Ionomers can be produced by:
a polymerising a monomer with an ionic co-monomer (e.g. styrene and sodium methacrylate)
b modifiying a non-ionic polymer through chemical process (e.g. polyethylene, polystyrene and PTFE)

The ionomer may be anionic or cationic. Polystyrene based ionomers are also known as ion-exchange resins. Cation exchange resins can be prepared by suspension polymerization of styrene with cross-linking agent (e.g. divinylbenzene), which is sulfonated to introduce sulphonic acid group (—SO₃H) into the benzene ring. Anion exchange resin can be made by copolymerizing styrene with divinylbenzene and vinylethylbenzene. Subsequently, the polymer may be treated with chloromethyl ether to introduce chloromethyl groups on the benzene ring followed by reaction with tertiary amines to form quaternary ammonium salts to obtain an anion exchange resin.

The carbon electrodes containing the ionomers can be used in FTC cells that are built either with or without ion selective membranes. In principle either anionic or cationic ionomer can be used for both the anode and the cathode. Also mixtures of anionic and cationic ionomers can be used as well as zwitterionic polymers for both the anode and the cathode. Nevertheless, it is preferred to use cationic ionomers for the anode and anionic ionomers for the cathode to obtain an increase in ion storage capacity and ion binding capacity. Ionomers that selectively can bind hydroxide ions or protons are preferably used. These ionomers enhance the buffer capacity of the FTC and hence reduce pH fluctuations during operation of the FTC

Suitable cationic polyelectrolytes in the context of the present invention are for example ion exchange resins containing styrene or acrylic copolymer. Commercially available ionomers of this type are styrene copolymers cross-linked with divinylbenzene. These copolymers containing quaternary ammonium or/and tertiary ammonium groups, such as DOWEX® 1x8 (ex DOW Chemicals), Powdex® PAO Series (ex Graver Technologies, LLC), A700OH (ex Finex), Purolite® A100 (ex Lenntech). Ionomers based on polyacrylic copolymer containing tertiary ammonium groups are also suitable, such as Purolite A847 (ex Lenntech) and WB-2 (ex Aldex Chemical Company, Ltd). There is a strong preference for ionomers that contain quaternary ammonium groups.

Suitable anionic ionomers are sulphonated and carboxylated polymers, and mixtures thereof. Therefore, suitable anionic ionomers in the context of the present invention are for example polystyrene based ionomers with sulfonic ion exchange group. Commercially available ionomers of this type are strongly acidic styrene copolymers cross-linked with divinylbenzene, such as DOWEX® 50Wx8 (ex DOW Chemicals), Powdex® PCH Series (ex Graver Technologies, LLC), C800H (ex Finex). Ionomers based on polyacrylic copolymer containing carboxylic acid groups may also be suitable, such as AMBERLITE® IRC86 (ex Lenntech) and POWDEX® PKH Series (ex Graver Technologies, LLC).

Both the cationic and anionic ionomers, preferably have a particle size of at least 0.1 μm, more preferably at least 1 μm, still more preferably at least 5 μm. The particle size is preferably not more than 2000 μm, preferably less than 500 μm, still more preferably less than 100 μm. There is a strong preference for anionic ionomers having a particle size of <300 μm, more preferably between 5 μm and 300 μm, even more preferably wherein at least 95% of the particles have a particle size <300 μm. The ionomer preferably have an ion exchange capacity of at least 0.2 meq/g, more preferably at least 1.0 meq/g, still more preferably at least 2.0 meq/g.

The ionomer may be present in the coating in a concentration of at least 1%, preferably at least 5%, more preferable at least 20% or even at least 40% by weight of the dry coating. The amount of carbon and ionomer may be adjusted so as to balance the capacitance of the anode and cathode electrodes. In practice this may imply that more ionomer and/or carbon may be used for the anode than for the cathode electrode.

### Solvent

The solvent, suitable for mixing the coating paste, may be any solvent suitable for dispersing the ionomers, desirably an aqueous solvent such as water or any other polar solvent, for example an alcohol, such as a polyol for example a triol such as glycerol or a dyol such as ethylene glycol. The glycerol can be a food grade glycerol so that the electrode can be used in an apparatus for drinking water. The solvent is generally evaporated from the paste to form a solid coating on the current collector. The evaporation may for instance be achieved by exposure to air (ambient or heated). The solvent may be present in an amount of 20-80% of the total paste, but is generally present in an amount of about 40-50% of the total paste, before drying. In an embodiment, after drying, the coating contains less than 25% solvent, less than 15% solvent, or less than 10% solvent.

### Method

In one embodiment the present invention provides a method for preparing a carbon coated current collector, comprising the steps of:

preparing a coating paste comprising:
carbon;
ionomer;
binder; and
solvent

applying the coating paste onto a graphite foil; and drying the coated current collector in order to evaporate the solvent.

Drying the coated current collector may be done at a temperature range from 15° C. to 120° C.

Preparing the charge barrier coating solution comprises:
charge barrier solution;
ionomer; and
solvent

applying the charge barrier onto the carbon coated current collector; and drying the charge barrier in order to evaporate the solvent.

Drying the charge barrier may be done at a temperature range from 30° C. to 120° C.

For the manufacturing of the coated current collector, the carbon paste may be applied by paste-, blade-, dip-spray- or spin coating as single layers or multiple layers as well as by gravure roll coating, extrusion coating or by lamination or screen printing. For example, the screen printing process consists of forcing the carbon paste through a stencil covered substrate, e.g. Grafoil® or through a wire mesh which has been mounted in a sturdy frame. In this case the carbon paste only goes through the open areas of the stencil and is deposited onto a printing substrate, e.g. Grafoil®, positioned below the frame.

Manual screen printing can be accomplished with only a few simple items: a sturdy frame, screen fabric, stencils, squeegees, and carbon paste. Automatic press equipment can be used which would greatly speed up the process. The current collector sheets may be coated on both sides with the carbon paste.

### Dry Carbon Coated Current Collector

The carbon layer as coated onto the carbon coated current collector, generally has a thickness of at least 50, preferably at least about 100, more preferably at least about 200 micrometer.

### Charge Barrier Layer

Charge barriers have been disclosed in U.S. Pat. No. 6,709,560 for use in FTC. The present invention provides as an embodiment a carbon coated current collector, as disclosed herein above, further comprising a charge barrier applied to the carbon coating layer, the charge barrier may be a membrane, selective for anions or cations, the charge barrier being applied to the carbon coating layer as a further coating layer or as a laminate layer.

In another embodiment, the invention provides the coated current collector according to the invention, comprising carbon, binder and ionomer, in combination with a separate conventional charge barrier as disclosed in U.S. Pat. No. 6,709,560.

Suitable membrane materials may be homogeneous or heterogeneous. Suitable membrane materials comprise anion exchange and/or cation exchange membrane materials, preferably ion exchange materials comprising strongly dissociating anionic groups and/or strongly dissociating cationic groups. Examples of such membrane materials are Neosepta™ range materials (ex Tokuyama), the range of PC-SA TMand PC-SK™ (ex PCA GmbH), ion exchange membrane materials Fumasep®, e.g. FKS™ FKE™ FAA™, FAD™ (ex FuMA-Tech GmbH), ion exchange membrane materials Ralex™ (ex Mega) or the Excellion™ range of heterogeneous membrane material (ex Snowpure).

For the manufacturing of the charge barrier, the charge barrier solution may be applied by paste-, blade-, dip-spray-, spin, slot die coating as single layers or multiple layers as well as by gravure roll coating, extrusion coating or by lamination. For example, the blade coating process applied the charge barrier solution on the coated current collector through the gap between support roller and edge of the knife. Size of this gap determines the thickness of coating, rest of the material is scraped off. This coating method provides large flexibility in types and parameters of coating solutions (range of viscosity: 100-50 000 mPas).

Automatic press equipment can be used which would greatly speed up the process. The coated current collector with the charge barrier may be coated on both sides.

### Coated Charge Barrier

The charge barrier made by the method of the invention may be coated onto the carbon coated current collector and generally would have a thickness of at least 2, preferably at least about 5, more preferably at least about 10 micrometer; and preferably less than 100, more preferably less than 50 micrometer.

### Current Collector

The current collector may be any common type of current collector. The material of which the current collector is made, is a conducting material. Suitable materials are e.g. carbon, such as graphite foil, or carbon mixtures with a high graphite content, metal, such as copper, titanium, platinum, (stainless) steel, nickel and aluminium. The current collector is generally in the form of a sheet. Such sheet is herein defined to be suitable to transport at least 33 Amps/m2 and up to 2000 Amps/m2. When a surface of graphite foil is used, such surface may be corona treated, plasma etched, chemically or mechanically abraded or oxidized to enhance binder adhesion. The thickness of a graphite current collector then typically becomes from 100 to 1000 micrometer, generally 200 to 500 micrometer.

FTC with Carbon Coated Current Collector Containing Ionomer

The carbon coated current collectors are especially useful in FTC devices that require low system cost for example in domestic appliances such as coffee makers, espresso machines, washing machines, dish washers, refrigerators with ice or water dispensers, steam irons, etc., where the removal of hardness ions such as calcium and magnesium, as well as other ions is beneficial. They can also be used for residential water treatment such as point of use devices as well as point of entry devices for whole households. These carbon-coated current collectors can also be used for commercial and industrial applications, e.g. water treatment in agriculture (e.g. treatment of ground water and surface water), boiler water, cooling towers, process water, pulp and paper, laboratory water, commercial laundry, commercial dish wash, waste water treatment, mining as well as for the production of ultra-pure water. Finally, the carbon coated current collectors comprising ionomers may be used for the removal of problem ions such as nitrate in e.g. swimming pools and arsenic and/or fluoride in e.g. ground water.

These and other aspects, features and advantages will become apparent to those of ordinary skill in the art from a reading of the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” are understood to include x and y. When for a specific feature multiple preferred ranges are described in the format “from x to y”, it is understood that all ranges combining the different endpoints are also contemplated.

### BRIEF DESCRIPTION OF THE FIGURES

Embodiments of the invention will be described, by way of example only, with reference to the accompanying schematic drawings in which corresponding reference symbols indicate corresponding parts, and in which;

FIG. 1a gives a schematic representation of the charging of the carbon coated current collector during the ion removal step according to the prior art.

FIG. 1b gives a schematic representation of the discharging of the carbon coated current collector during the electrode regeneration step at reversed potential according to the prior art;

FIG. 2a shows carbon coated current collectors comprising ionomers according to an embodiment of the invention;

FIG. 2b shows a carbon coated current collector comprising ionomers, whereby hydroxide ions are adsorbed onto the ionomers of the anode;

FIG. 2c shows a carbon coated current collector comprising ionomers, whereby protons are adsorbed onto the ionomers of the cathode according to an embodiment of the invention;

FIG. 3 shows reduced pH fluctuations during the discharging and charging of the carbon coated current collector at 1.2l/m²/min flow using ionomers;

FIG. 4 shows reduced pH fluctuations during the discharging and charging of the carbon coated current collector at 1.6l/m²/min flow using ionomers;

FIG. 5 shows cell voltages during the discharging and charging of the carbon coated current collector at 1.2 l/m²/min flow;

FIG. 6 shows cell voltages during the discharging and charging of the carbon coated current collector at 1.6l/m²/min flow;

FIG. 7 shows reduced pH fluctuations during the discharging and charging of the carbon coated current collector at 1.2l/m²/min flow;

FIG. 8 shows stable average cell voltage for the coated current collector comprising ionomers measured during the charging of the carbon coated current collector at 1.2 l/m²/min flow over a period of 80 days;

FIG. 9 shows stable pressure drop for the FTC module with the coated current collector comprising ionomers measured over a period of 80 days at 1.2 l/m²/min flow; and,

FIG. 10 shows pictures of the coated current collector with a spacer on top after 80 days of operation. At the left (a) is presented picture of the coated current collector without ionomer with severe scaling and at the right (b) the coated current collector with addition of 16.6 wt % of ionomer gave a clean surface without visible scaling.

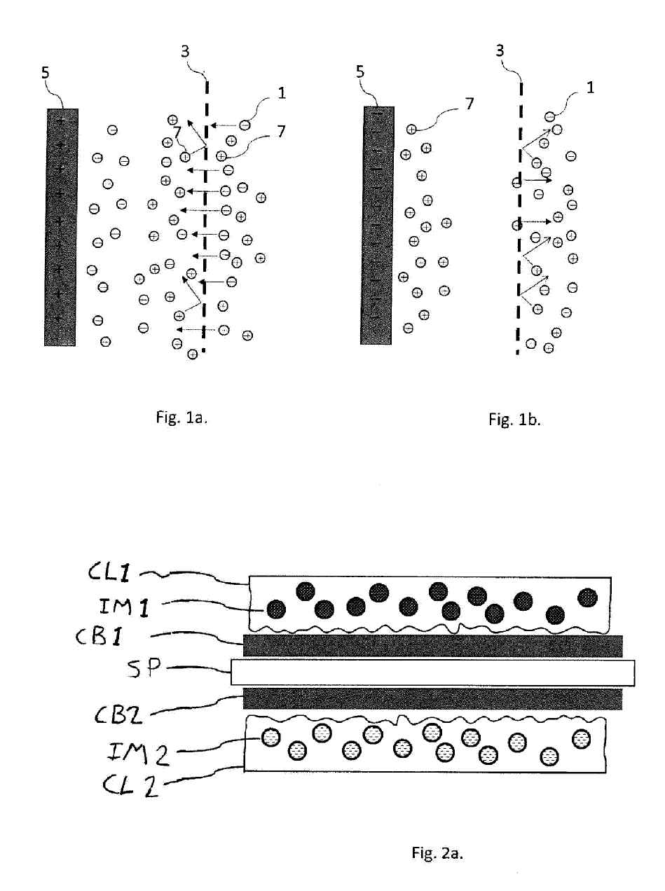

### DETAILED DESCRIPTION

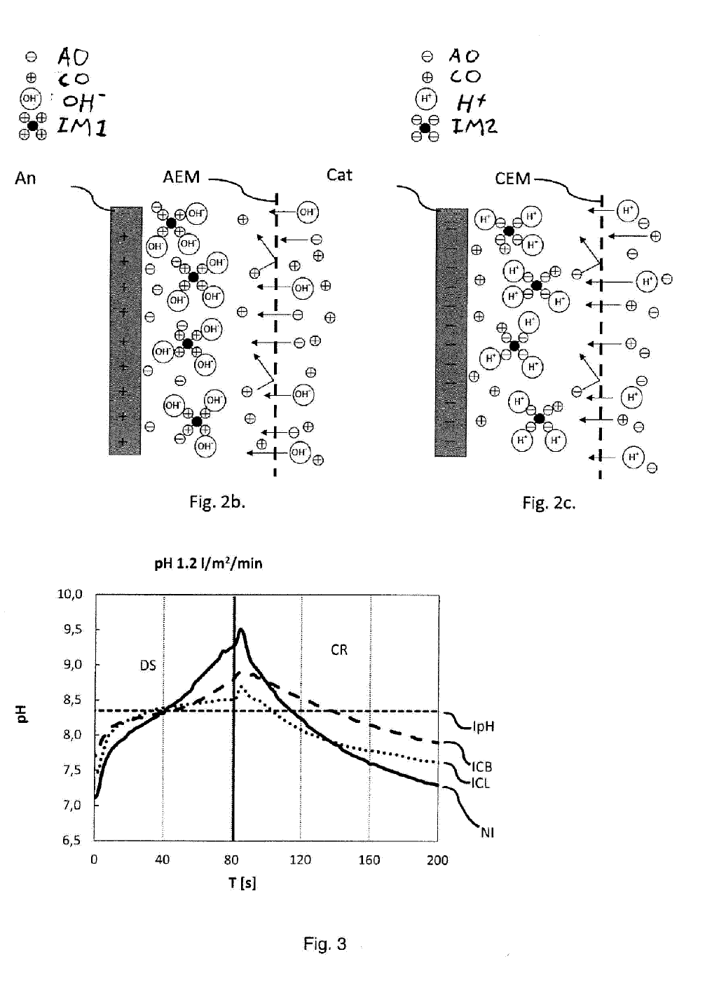

FIG. 2a shows an apparatus for removal of ions from water according to an embodiment of the invention. The apparatus comprising:

a first functional layer system comprising a carbon coated first current collector CL1 and optionally a first charge barrier layer CB1;

a second functional layer system comprising a carbon coated second current collector CL2 and optionally a second charge barrier CB2; and

a spacer SP in between the first and second functional layer system to allow water to flow in between the first and second functional layer system. Ionomer IM1 is provided to the first functional layer system in the carbon coated first current collector CL1. Ionomer IM2 is provided to second functional layer system in the carbon coated second current collector CL2.

FIG. 2b shows an anode AN with a carbon coating forming the carbon coated first current collector (CL1 in FIG. 2a) which comprise positively charged ionomers IM1. There is an anodic charge barrier AEM which allows hydroxide ions OH⁻ and anions AO to pass but doesn't allow cations CO to pass. During a charging step the anode AN is positively charged and the carbon coated first current collector adsorbs anions AO. The hydroxide ions OH⁻ are also attracted and adsorbed onto the positively charged ionomers IM1 thereby limiting PH fluctuations and reducing risk of scaling.

FIG. 2c shows a cathode CAT with a carbon coating forming the carbon coated second current collector (CL2 in FIG. 2a) which comprise negatively charged ionomers IM2. There is an cationic charge barrier CEM which allows protons H⁺ and cations CO to pass but doesn't allow anions AO to pass. During a charging step the cathode CAT is negatively charged and the carbon coated second current collector adsorbs cations CO. The protons H⁺ are also attracted and adsorbed onto the negatively charged ionomers IM2 thereby limiting PH fluctuations and reducing risk of scaling.

The invention will now be illustrated by means of the following non-limiting examples.

### Example 1

In this example we used ion exchange resin particles as ionomers. These particles contain quaternary ammonium groups, which increase the hydroxide ion adsorption capacity. These particles were added to the charge barrier coating solution in order to improve hydroxide adsorption capacity of the charge barrier. In example 1 the charge barrier may be a membrane.

Sample 1

A functional layer system comprising a carbon coated current collector and a charge barrier layer comprising ionomer was prepared in the following way:
Step 1: Add tap water: 33 wt %
Step 2: Add carbon black 1.4 wt %
Step 3: Add glycerol: 32 wt %
Step 4: Add activated carbon (ex Norit): 31.3 wt % (carbon)
Step 5: Add binder 2.3 wt %

After every step the dispersion is thoroughly mixed with a mixer.
Step 6: Spread the paste on the graphite foil (speed: 5 mm/s) and dry the coating paste to make a carbon coated first current collector.
Step 7: Add 30 wt % ion exchange resin particles (ionomer, particle size 10-200 um) with quaternary ammonium group to a 25-30% wt membrane solution in N-methyl-2-pyrolidone (NMP) solvent to make the charge barrier mixture comprising ionomer. The membrane solution is based on polyaromatic polymer with quaternary ammonium groups with ion exchange capacity 2.0-2.5 meq/g dry polymer.
Step 8: Coat the charge barrier mixture of step 7 by universal applicator Zenther ZUA 2000 connected to Zehntner-Automatic film applicator ZAA 2300 with a thickness of 215 μm onto the carbon coated current collector of step 6 and dry.

Sample 2

A functional layer system comprising a carbon coated current collector comprising ionomer and a charge barrier layer was prepared in the following way:
Step 1: Add tap water: 33 wt %
Step 2: Add carbon black 1.4 wt %
Step 3: Add glycerol: 32.2 wt %
Step 4: Add activated carbon (ex Norit): 14.5 wt % (carbon)
Step 5: Add 16.6 wt % ionomer in the form of ion exchange resin (particle size 10-200 um) with quaternary ammonium group:
Step 6: Add binder 2.3 wt %

After every step the dispersion is thoroughly mixed with a mixer
Step 7: Spread the mixture of step 1 to 6 on the graphite foil at speed of 5 mm/s and dry the coating paste to make a coated current collector with ionomer.
Step 8: Coat a 25-30% wt membrane solution in N-methyl-2-pyrolidone (NMP) solvent.

This solution is based on polyaromatic polymer with quaternary ammonium groups with ion exchange capacity 2.0-2.5 meq/g dry polymer by universal applicator Zenther ZUA 2000 connected to Zehntner-Automatic film applicator ZAA 2300 with a thickness of 150 μm to crate a charge barrier and dry.

The ionomer e.g. the ion exchange resin particles were added to the carbon paste in order to improve hydroxide adsorption capacity of carbon coated current collector.

Sample 3

As a reference we prepared a carbon coated current collector with on top a membrane without addition of ionomer e.g. ion exchange resin.

Coated current collector without ionomer was prepared in the following way:
Step 1: Add tap water: 33 wt %
Step 2: Add carbon black 1.4 wt %
Step 3: Add glycerol: 32 wt %
Step 4: Add activated carbon (ex Norit): 31.3 wt % (carbon)
Step 5: Add binder 2.3 wt %

After every step the dispersion is thoroughly mixed with a mixer
Step 6: Spread the paste on the graphite foil (speed: 5 mm/s) and dry the coating paste to make a carbon coated current collector.
Step 7: Coat a 25-30% wt membrane solution in N-methyl-2-pyrolidone (NMP) solvent.

This solution is based on polyaromatic polymer with quaternary ammonium groups with ion exchange capacity 2.0-2.5 meq/g dry polymer by universal applicator Zenther ZUA 2000 connected to Zehntner-Automatic film applicator ZAA 2300 with a thickness of 150 μm to crate a charge barrier and dry.

The FTC stack comprises 20 repeating cells which are sandwiched between two endplates made from PVC. Each cell comprises a carbon coated first current collector (thickness δ=500 μm), coated anion exchange membrane (δ≈30 μm) (together defining a first functional layer system) a woven spacer (δ=110 μm) and a second functional layer system comprising a cation exchange membrane (δ≈30 μm) and a carbon coated second current collector (thickness δ=500 μm). The current collectors can act either as an anode or a cathode, whereby during purification the cations migrate to the cathode and the anions to the anode. The membrane ion exchange capacity is presented in meq/m² and is substantially increased by addition of ionomer (Table 1)

TABLE 1
Increase of ion exchange capacity by added
ionomer in the samples of example 1.

| | Standard Charge | Added Ionomer | |
|---|---|---|---|
| | Barrier ion | ion exchange | |
| | exchange capacity | capacity* | Increase |
| Sample: | [meq/m²] | [meg/m²] | [%] |
| 1. Ionomer in charge | 95 | 65 | 68.4 |
| barrier (30 wt %) | | | (65/95) |
| 2. Ionomer in coated | 95 | 205 | 216 |
| current collector | | | (205/95) |
| (16.6 wt %) | | | |
| 3. No ionomer | 95 | 0 | 0 |
| (reference) | | | (0/95) |

*calculated.

The FTC stack was operated under constant current conditions with set TDS removal to 70% and water recover was set to 58%. Tap water with a conductivity of 500-540 μS/cm was used in this test. Charging cycle (purification) length was 120 seconds and discharging (regeneration) cycle was 80 seconds. The FTC module was operated at flow of 1.2 l/min/m² spacer area and an electrical current during purification was set to 3.6 A and during regeneration was set to 5.3 A. The FTC module operated at higher flow of 1.6l/min/m² spacer area was operated during purification at current of 4.9 A and during regeneration current was set to 7.3 A.

FIG. 3 shows the pH profile as a function of time (T) in seconds (s) during discharging DS and charging CR of the carbon coated current collector at flow of 1.2 l/m2/min once equilibrium is reached after a few cycles. In practice we start with discharge because we want to make sure that we start with no charge on the current collectors. FIG. 3 shows while the PH of the incoming water IPH is kept constant a significant reduction of pH fluctuations by addition of ionomer to the charge barrier ICB and to the carbon coated current collector ICL with respect to the reference NI. The ion exchange capacity is higher by 68.4% and by 216%, respectively.

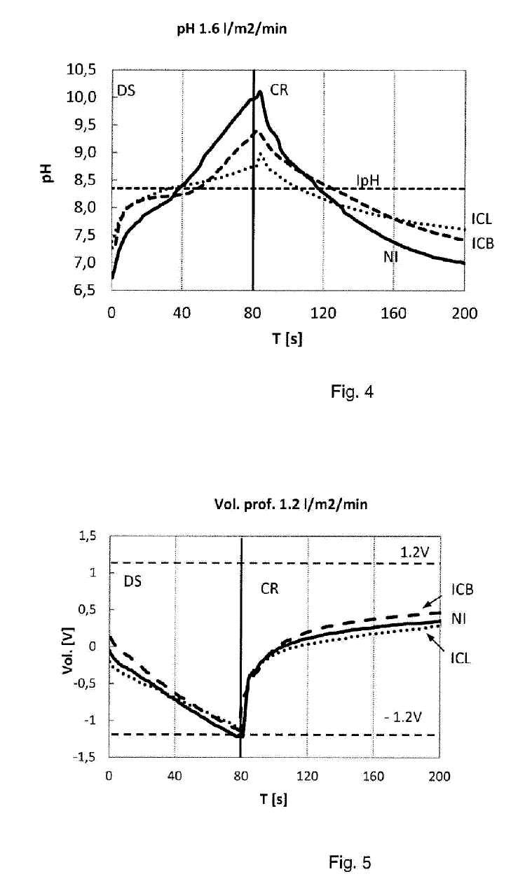

FIG. 4 shows pH profiles as a function of time (T) in seconds (s) measured during the discharging DS and charging CR of the carbon coated current collector at flow of 1.6 l/m2/min. FIG. 4 shows that at higher ionic fluxes caused by higher flow of 1.6 l/min/m² and current, the pH fluctuations are also significantly reduced by addition of the ionomer to the charge barrier ICB (ion exchange capacity increase 68.4%) and/or to the carbon coated current collector ICL (ion exchange capacity increase 216%).

Voltage profiles provide information about the system resistance, whereby lower cell voltage indicates reduced resistance in the cell. FIG. 5 shows cell voltages V as a function of time (T) in seconds (s) during the discharging DS and charging CR of the carbon coated current collector at flow of 1.2l/m2/min. FIG. 5 shows that the cell resistance of the carbon coated current collector with ionomer ICL, the charge barrier with ionomer ICB and the reference without ionomer NI are comparable at low flow conditions. The voltage is limited LM to +/−1.2V.

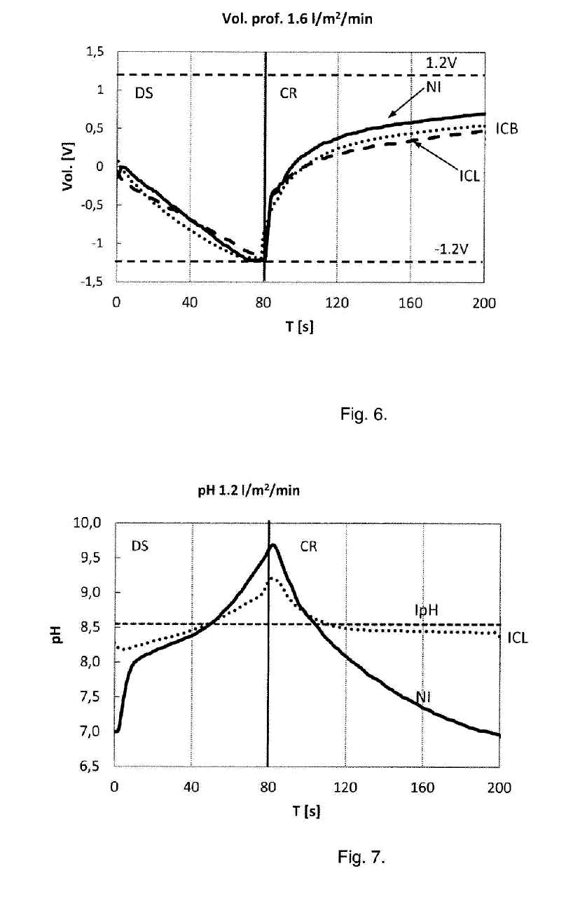

FIG. 6 shows the cell voltages during the discharging DS and charging CR of the carbon coated current collector at a flow of 1.6 l/m²/min. FIG. 6 shows that at higher flow of 1.6l/m²/min, the addition of ionomer either to the coated current collector ICL or to the charge barrier ICB reduced the cell resistance.

### Example 2

The example shows the extended lifetime of the apparatus for deionizing water by incorporating ionomer in the carbon coated current collector. In this example we also used ion exchange resin particles as ionomers. These particles contain quaternary ammonium groups, which increase the hydroxide ion adsorption capacity. In this example the charge barrier is called a membrane. In this example we used the coated current collector without ionomer as a reference. Preparation of both materials, the carbon coated current collector with and without ionomer is described in example 1 and ion exchange capacity is listed in Table 1.

The FTC module comprise 18 repeating cells which are sandwiched between two endplates made from PVC. Each cell comprises a coated current collector (thickness δ=500 μm), coated anion exchange membranes (δ≈′30 μm) and cation exchange membrane (δ≈30 μm) and a woven spacer (δ=170 μm). The electrodes can act either as an anode or a cathode, whereby during purification the cations migrate to the cathode (which is negatively charged) and the anions to the anode (which is positively charged). Membrane ion exchange capacity presented in meq/m² of electrode surface is increased by addition of ionomer (Table 1)

The FTC stack was operated under constant current conditions with set TDS removal to 70% and water recover to 58%. Tap water with a conductivity of 500-540 ρS/cm was used in this experiment. Charging cycle (purification) length was 120 s and discharging (regeneration) cycle was set to 80 s. The FTC module was operated at flow of 1.2 l/min/m² spacer area and current during purification was set to 3.4 A and during regeneration to 5.4 A.

FIG. 7 presents pH profile as a function of time T during a regeneration cycle (DS discharge of ions) and during purification cycle (CR charging of ions) measured at flow of 1.2 l/min/m². FIG. 7 shows pH profiles measured during the discharging DS and charging CR of the carbon coated current collector at flow of 1.2 l/m2/min. FIG. 7 shows significant reduction of pH fluctuations by addition of ionomer to the carbon coated current collector ICL with respect to the current collector without ionomer NI, which increased ion exchange capacity by 216%.

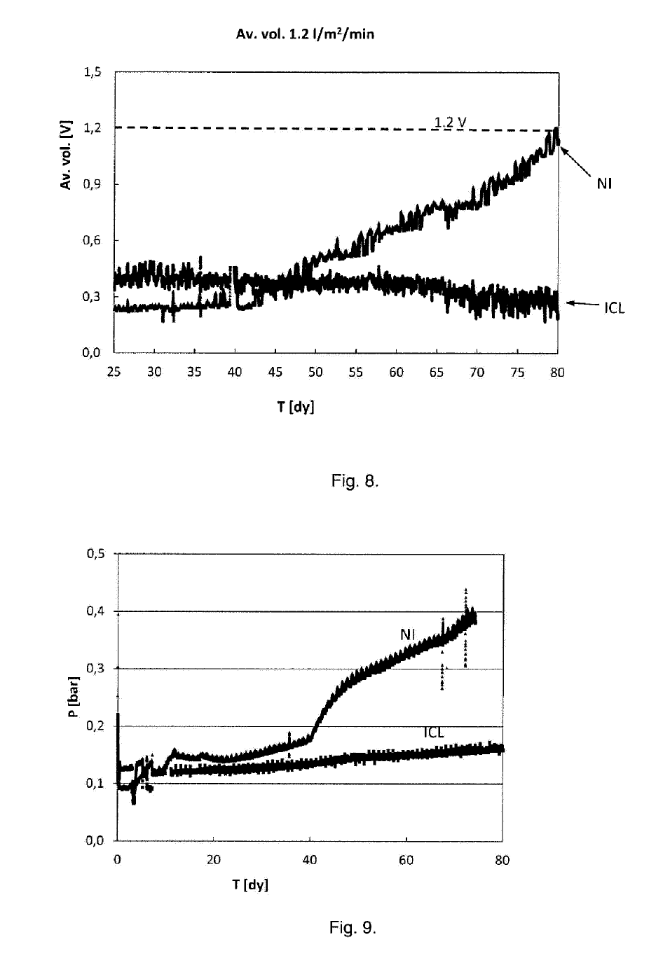

FIG. 8 shows the average cell voltage measured during the charging of the carbon coated current collector at 1.2l/m2/min flow over an extended period of time T in days (dy). FIG. 8 shows an average cell voltage measured during purification cycle at low flow conditions (1.2 l/m²/min). Average cell voltage of the module with ionomer provided to the carbon coated current collector ICL is stable over a period of 80 days. On the other hand, the module without addition of ionomer NI shows that average voltage starts to increase from day 40, which indicates reduced lifetime of the FTC module. This reduction of lifetime seems to be caused by scale formation in the flow channel of the FTC module.

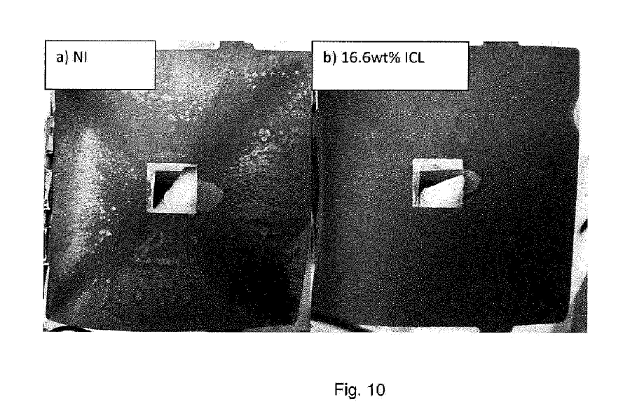

FIG. 9 shows the pressure drop P in Bar of the FTC module with the coated current collector with ionomer ICL and without ionomer NI measured over a period T of 80 days (dy) at 1.2 l/m2/min flow. FIG. 9 shows a pressure drop P of the two FTC modules at flow of 1.2 l/m²/min flow during a charging cycle. FTC module with ionomer in the coated current collector ICL shows stable long term performance, where the measured pressure drop P for the FTC module without ionomer NI exponentially increases from day 40. These results indicate that the lifetime of the module is significantly reduced for the FTC module without ionomer NI and the reason for this behaviour is scaling of the flow channel (FIG. 10).

FIG. 10 shows pictures of a coated current collector with coated on top a charge barrier and a spacer on top after finishing the experiment. At the left (a) is presented a picture of the coated current collector with a spacer without ionomer and at the right (b) is presented the coated current collector with addition of 16.6 wt % of ionomer into carbon coated current collector. FIG. 10 shows that the coated current collector without ionomer had severe scaling in the flow channel, which translates to significantly reduced life time (FIG. 9). The coated current collector with addition of ionomer shows no scaling (right side). These results show that addition of ionomer into the electrode or/and membrane limits pH fluctuations and extends lifetime of the FTC module.

It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Furthermore, the terms and phrases used herein are not intended to be limiting, but rather, to provide an understandable description of the invention.

The terms “a” or “an”, as used herein, are defined as one or more than one. The term another, as used herein, is defined as at least a second or more. The terms including and/or having, as used herein, are defined as comprising (i.e., not excluding other elements or steps). Any reference signs in the claims should not be construed as limiting the scope of the claims or the invention. The mere fact that certain measures are recited in mutually different dependent claims does not indicate that a combination of these measures cannot be used to advantage. The scope of the invention is only limited by the following claims.

1. An apparatus for removal of ions from water, the apparatus comprising:
a first functional layer system comprising a carbon coated first current collector;
a second functional layer system comprising a carbon coated second current collector; and
a spacer in between the first and second functional layer systems to allow water to flow in between the first and second functional layer systems, wherein an ionomer is provided to the first functional layer system and/or the second functional layer system and wherein the ionomer contains quaternary ammonium groups and wherein the ionomer is a particle with a size smaller than 300 μm.

2. The apparatus according to claim 1, wherein a charge density of the ionomer is at least between 0.2 meq and 8 meq per gram dry weight of ionomer.

3. The apparatus according to claim 1, wherein the ionomer is a particle with a size smaller than 100 μm.

4. The apparatus according to claim 1, wherein the ionomer comprises an ion exchange resin.

5. The apparatus according to claim 1, wherein the ionomer comprises an ionic group to bind hydroxide ions or protons.

6. The apparatus according to claim 1, wherein the second functional layer system comprises a negatively charged ionomer capable of adsorbing protons.

7. The apparatus according to claim 1, wherein the first functional layer system comprises a first charge barrier and the first charge barrier is capable of allowing the selective transport of anions through the first charge barrier.

8. The apparatus according to claim 8, wherein the second functional layer system comprises a second charge barrier and the second charge barrier is capable of allowing the selective transport of cations through the second charge barrier.

9. The apparatus according to claim 1, wherein the first current collector comprises a positively charged ionomer and/or the second current collector comprises a negatively charged ionomer.

10. The apparatus according to claim 1, wherein the second current collector is the cathode and the first current collector is the anode and/or the ionomer of the first and second functional layer systems have an opposite charge.

11. A method of producing a carbon coated current collector comprising an ionomer, the method comprising:
preparing a carbon paste comprising the ionomer, wherein the ionomer contains quaternary ammonium groups and wherein the ionomer is a particle with a size smaller than 300 μm;
providing a graphite foil; and
coating the carbon paste onto the graphite foil.

12. A method of producing a charge barrier comprising an ionomer, the method comprising:
preparing a charge barrier solution comprising the ionomer, wherein the ionomer contains quaternary ammonium groups and wherein the ionomer is a particle with a size smaller than 300 μm; and
coating the charge barrier solution into a layer.

13. The method according to claim 12, wherein the charge barrier solution is coated on a carbon coated current collector.

14. A functional layer system comprising a carbon coated current collector, wherein an ionomer is provided to the functional layer system, wherein the ionomer contains quaternary ammonium groups and wherein the ionomer is a particle with a size smaller than 300 μm.

15. The apparatus according to claim 2, wherein a charge density of the ionomer is at least between 1.0 meq and 6 meq per gram dry weight of ionomer.

16. The apparatus according to claim 6, wherein the negatively charged ionomer comprises a sulphonic and/or carboxylic acid group.

17. The apparatus according to claim 7, wherein the first charge barrier comprises a positively charged ionomer.

18. The apparatus according to claim 8, wherein the second charge barrier comprises a negatively charged ionomer.

19. The method according to claim 11, wherein the carbon paste comprises between 5 and 40 wt % ionomer.

20. The method according to claim 12, wherein the charge barrier solution comprises between 5 and 50 wt % ionomer.
